(19) United States
(12) Patent Application Publication
(10) Pub. No.: US 2020/0403568 A1
(43) Pub. Date: Dec. 24, 2020

(54) APPARATUS FOR COOLING A PHOTOVOLTAIC MODULE

(71) Applicant: NEWSOUTH INNOVATIONS PTY LIMITED, Sydney, New South Wales (AU)

(72) Inventors: Martin Andrew GREEN, Bronte, New South Wales (AU); Yajie Jessica JIANG, Caringbah, New South Wales (AU); Mark KEEVERS, Maroubra, New South Wales (AU); Nicholas EKINSDAUKES, Kensington, New South Wales (AU); Zibo ZHOU, Rhodes, New South Wales (AU)

(21) Appl. No.: 16/975,370

(22) PCT Filed: Feb. 27, 2019
(86) PCT No.: PCT/AU2019/050170

§ 371 Date: Aug. 24, 2020

(30) Foreign Application Priority Data
Feb. 27, 2018 (AU) 2018900641

(51) Int. Cl. H02S 40/42; H02S 30/10

(52) U.S. Cl. CPC H02S 40/425; H02S 30/10

(57) ABSTRACT

Disclosed is an assembly for mounting to a photovoltaic module. The photovoltaic module has a radiation receiving surface and a second surface opposite the radiation receiving surface. At least one of the radiation receiving surface and the second surfaces are also arranged to transmit radiation. A photon absorbing material is positioned between the first and second surfaces. The assembly comprises a cooling element configured to mount to the at least one of the radiation receiving surface and the second surface. The cooling element has a plurality of protrusions that are configured to increase a heat transfer coefficient of the photovoltaic module compared to a heat transfer coefficient that the photovoltaic module would have without the plurality of protrusions.

### TECHNICAL FIELD OF THE INVENTION

The present invention relates to, particularly but not exclusively, apparatus, modules and systems for cooling photovoltaic modules.

### BACKGROUND OF THE INVENTION

Photovoltaic modules are now used for various applications. It is known that the conversion efficiency of photovoltaic modules is adversely affected if the temperature of the photovoltaic modules increases. Photovoltaic modules often operate in bright sunlight, typically 20-30° C. above ambient temperature. This not only reduces the energy production of a photovoltaic module by 0.4-0.5% (relative) for every degree increase in temperature (up to 15% for a 30° C. increase in temperature), but also accelerates all known degradation processes and reduces the lifespan of the photovoltaic module below a lifespan that is otherwise achievable.

In addition, photovoltaic modules typically degrade 0.5% (relative) in output for each year in the field, with photovoltaic modules normally warranted to be above 80% of their initial rating after 25 years of field exposure. Further, long time testing of specific degradation modes suggest degradation rates approximately double for every 10° C. increase in temperature. This suggests that photovoltaic modules operating at a temperature lower than the above-mentioned typical operating temperature could not only increase their energy production, but could also have a reduced degradation and could consequently be used for extended periods of time than otherwise possible.

### SUMMARY OF THE INVENTION

In accordance with a first aspect of the present invention there is provided an assembly for mounting to a photovoltaic module, the photovoltaic module having a radiation receiving surface and a second surface opposite the radiation receiving surface, at least one of the radiation receiving surface and the second surface also being arranged to transmit radiation, and a photon absorbing material positioned between the first and second surfaces, the assembly comprising:
a cooling element configured to mount to at least one of the radiation receiving surface and the second surface, the cooling element having a plurality of protrusions that are configured to increase a heat transfer coefficient of the photovoltaic module compared to a heat transfer coefficient that the photovoltaic module would have without the plurality of protrusions.

Increasing the heat transfer coefficient of the module will help to reduce the operating temperature of the module in use. This will help to increase the efficiency and performance of the module, and increase the service life since degradation of the module is dependent on the temperatures reached by the module in use.

The protrusions may extend away from the second surface and may be attached (directly or indirectly) at attachment points, attachment lines or attachment regions, to at least one of the radiation receiving surface and the second surface. For example, the cooling element may comprise a (thin) sheet or strip having a planer surface and the protrusions may extend from attachment points at the surface of the sheet or strip at an angle relative to the surface of the sheet, which may be attached to the second surface.

The sheet or strip may be integral with the protrusions. The sheet or strip and the protrusions may be made from plastic and/or metal.

The cooling element may be mounted to at least one of the radiation receiving surface and the second surface with an adhesive. The adhesive may be thermally conducting adhesive.

Each protrusion may have a proximal end configured for attachment to at least one of the radiation receiving surface and the second surface and a distal end opposite the proximal end. Each protrusion may be sized so that the distal end extends past a hot air boundary layer that is generated in use of the photovoltaic module.

Each protrusion may be sized so that, in use of the module, a substantially laminar flow convection current comprising the hot air boundary layer moves past each protrusion and each protrusion disrupts the laminar flow to form vortices. The disrupted laminar flow (or vortex) may mix cooler air positioned adjacent the hot air boundary layer in to cool the hot air boundary layer, for example by sucking cooled air into the hot air boundary layer to cool the hot air boundary layer. For example, the protrusions may act as vortex generators. In some embodiments, the vortices may include turbulent flow. In some embodiments, the protrusions may promote turbulent flow.

The protrusions may be flaps. The flaps may be elongate. The flaps may be substantially triangular in shape. A corner, point or end-portion of the triangular shape may be configured to be positioned proximal to the plane of at least one of the radiation receiving surface and the second surface for attachment at an attachment point and an edge of the triangular shape may be positioned distally away from the plane of at least one of the radiation receiving surface and the second surface.

The protrusions may also be provided as a plurality of pyramids extending away from at least one of the radiation receiving surface and the second surface. The pyramids may have a width extending along a base and a height extending from a base to a tip. The width may be approximately double the height. In an embodiment, the width is approximately 1.0 cm and the height is approximately 1.5 cm.

In some embodiments, heat absorbed by the module can be transferred to the cooling element, which comprises the above-mentioned protrusions. This means that the cooling element may act as a thermal sink or radiator. The cooling element may be electrically insulating.

The cooling element may also be one of a plurality of cooling elements and each cooling element may comprise one or more of the protrusions. The cooling element may comprise a frame.

In accordance with a second aspect of the present invention there is provided a photovoltaic module comprising the assembly of the first aspect.

A further aspect of the invention provides a photovoltaic module comprising:
a radiation receiving surface;
a second surface opposite the radiation receiving surface, at least one of the radiation receiving surface and the second surface also being arranged to transmit radiation; and
a plurality of protrusions extending from at least one of the radiation receiving surface and the second surface, the protrusions being configured to increase a heat transfer coefficient of the photovoltaic module compared to a heat transfer coefficient that the photovoltaic module would have without the protrusions.

In some embodiments, the protrusions are otherwise as defined in the first aspect.

In accordance with a third aspect of the present invention there is provided a photovoltaic module comprising a radiation receiving surface and a second surface opposite the radiation receiving surface,
wherein the second surface comprises a layer of electrically insulating and thermally conductive material configured to engage with a support frame that mounts the module to, or comprises, a support structure, and
wherein the layer of electrically insulating and thermally conductive material is configured to increase a heat transfer coefficient between the module and the support frame compared to a heat transfer coefficient that the module would have without the layer of electrically insulating and thermally conductive material.

Increasing the heat transfer between the module and the support structure will help to reduce the operational temperature of the module. This will help to increase the efficiency and performance of the module, and increase the service life since degradation of the module is proportional to the temperatures reached by the module in use. If the support frame has sufficient thermal mass, then the frame may function as a heat sink or direct heat to the support structure, for example a module mounting structure.

The layer of electrically insulating and thermally conductive material may be integrated into the module. The module may be one of a plurality of layers of electrically insulating and thermally conductive material. The layer of electrically insulating and thermally conductive material may comprise a metallic thermal conductor that is insulated from the module. The thermal conductor may be Al and/or Cu-based. Alternatively, the thermal conductor may be a material such as tape cast alumina with good thermal properties and a good electrical insulator.

The layer of electrically insulating and thermally conductive material may be configured to engage with the support structure through face-to-face contact. For example, a planar face of the electrically insulating and thermally conductive material may be placed in contact with a complementary planar face of the support frame. A conductive paste may be provided between the planar faces to increase thermal conductivity between the electrically insulating and thermally conductive material and the support frame. The layer of electrically insulating and thermally conductive material may be provided as a thermally conductive electrical insulator that is used to electrically insulate the module from the frame. For frameless modules, a non-structural frame may be added to the module to protect module edges while providing thermal benefits.

In accordance with a fourth aspect of the present invention there is provided a support frame for mounting a photovoltaic module to a support structure, the photovoltaic module having a radiation receiving surface and a second surface opposite the radiation receiving surface, the support frame in use absorbing heat from the photovoltaic module, the support frame comprising: one or more features being configured to promote heat transfer from the support frame to a convection current when the photovoltaic module is exposed to a flow of air during use of the photovoltaic module.

The one or more features may include protrusions and valleys. The valleys may be provided as apertures in the frame. The one or more features may include apertures provided in the support frame. The apertures may each have an axis that is aligned parallel to a longitudinal direction in which the convection currents pass over the second surface in use of the photovoltaic module. The support frame may be integral with the module. The support frame may extend around a perimeter of the photovoltaic module. If the support frame acts as a heat sink and is in thermal communication with the module, the one or more features may help to dissipate the heat in the frame. For example, the one or more features may help to increase heat exchange/transfer between the support frame and an environment surrounding the support frame. This may further help to reduce the operational temperature of the module in use. The frame may be provided with a layer that can substantially reflect light at visible wavelengths whilst increasing infrared emissions from the frame. This may help to reduce the temperature of the frame by reducing the thermal radiation that the frame absorbs from visible light, whilst emitting heat as infrared radiation. The support frame may be formed from an electrically insulating and thermally conductive material.

In accordance with a fifth aspect of the present invention there is provided a photovoltaic module as set forth above comprising the assembly as set forth above and a support frame as set forth above.

In accordance with a sixth aspect of the present invention there is provided a photovoltaic module as set forth above comprising the photovoltaic module as set forth above and a frame as set forth above.

The protrusions may extend from the layer of electrically insulating and thermally conductive material. The frame configured to mount to the second surface may be formed from an electrically insulating and thermally conductive material.

An embodiment provides a system for cooling a photovoltaic module, the photovoltaic module having a radiation receiving surface and a second surface opposite the radiation receiving surface, the system comprising:
an attachment point or area defining a base configured to be mounted to the second surface; and
one or more protrusions connected to and extending from the attachment point or area.

The system may further comprise a planar electrically insulating and thermally conductive material configured to engage with a support frame that mounts the module to a support structure.

The support frame may be a support frame segment that is configured to attach to the module. The support frame segment may comprise one or more features being configured to control one or more convection currents associated with the use of the photovoltaic module. The planar electrically insulating and thermally conductive material, attachment point and/or support frame segment may be mounted to the second surface with an adhesive.

### BRIEF DESCRIPTION OF THE DRAWINGS

Embodiments of the invention will now be described, by way of example, with reference to the accompanying drawings in which:

FIG. 1 shows an embodiment of a photovoltaic module assembly;

FIG. 2 shows a COMSOL simulation of the effect of a small flap on the local heat transfer coefficient in an embodiment;

FIG. 3 shows COMSOL simulation of free convection from module front and rear surfaces in an embodiment;

FIG. 4 shows COMSOL simulations of heat transfer coefficient for free convective and radiative heat transfer from a planar rear section of a module followed by a textured segment in an embodiment;

FIG. 5 shows COMSOL simulations of radiative emission for free convective and radiative heat transfer from a planar rear section of a module followed by a textured segment in an embodiment;

FIG. 6 shows an infrared image showing the nominal temperature distribution near an embodiment of a frame of an operating solar module superimposed on the outlines from an optical image;

FIG. 7 shows an embodiment of a photovoltaic module assembly;

FIG. 8 shows an embodiment of a frame; and

FIG. 9 shows the velocity cross section similar to FIG. 3 but with module frames included.

### DETAILED DESCRIPTION OF EMBODIMENTS

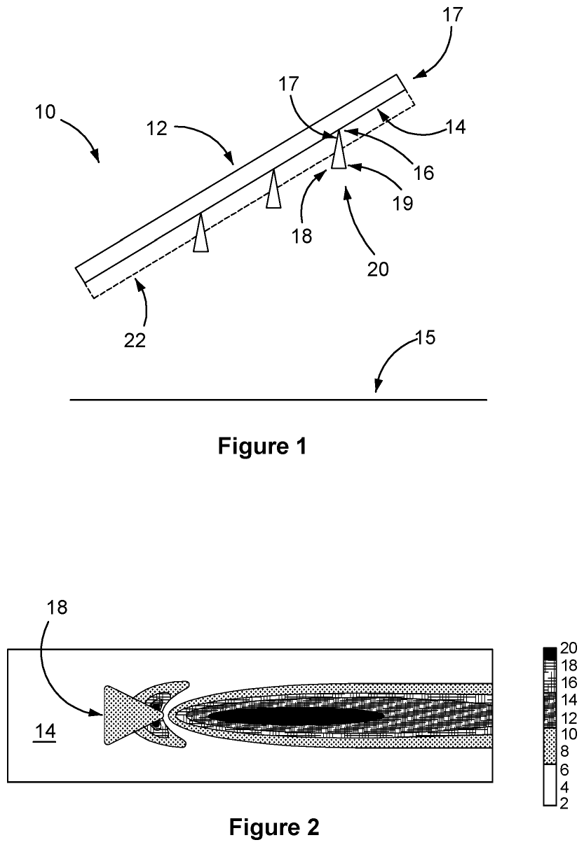

An embodiment of an assembly 20 for mounting to a photovoltaic module 10 is shown in FIG. 1. The module 10 has a radiation receiving surface in the form of top surface 12 and a second surface in the form of a bottom surface 14 opposite the top surface 12. In some embodiments the bottom surface 14 can also transmit radiation. The module is mounted at angled orientation relative to horizontal line 15. A photon absorbing material is positioned between the top surface 12 and bottom surface 14.

Throughout the specification, the terms “top” and “bottom” are used interchangeably with the terms “front” and “rear” (or “back”) surfaces, respectively, of the module 10. However, the terms “top”, “bottom”, “front” and “rear” are not intended to limit the module to any particular orientation.

The assembly 20 comprises elongate protrusions, which in this embodiment are provided in the form of substantially triangular flaps 18. The flaps 18 are attached to the bottom surface 14 at attachment points 16. The flaps 18 are configured to be angled relative to the bottom surface 14. In the embodiment of FIG. 1, a point (i.e. corner) of each flap 18 is located at the attachment point 16 to form a proximal end 17, and an edge (i.e. side) of each flap 18 forms a distal end 19. The assembly 20 may comprise a rear module cover sheet (or sheets, not shown) which may or may not be integrally formed with the flaps 18 and via which the flaps 18 are mounted to the bottom surface 14. The sheet with the attachment point 16 and the flaps 18 may be attached to the bottom surface 14 using a suitable thermally conductive adhesive.

For example, the flaps 18 may be formed by embossing corresponding shapes out of a rear module cover sheet such that these shapes, which form a plurality of the flaps 18, are only in contact with other remaining (planar) portions of the rear module cover sheet at the attachment points 16. The flaps 18 may subsequently be bent outwardly at the attachment point 16 and other (remaining) planar portions of the rear module cover sheet may then be attached to the bottom surface 14 using the suitable thermally conducting adhesive.

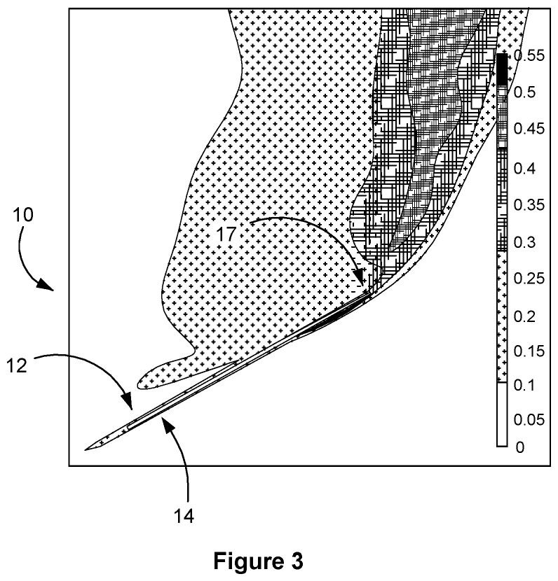

The distal end of each flap 18 extends past a hot air boundary layer, as represented by dashed area 22. The hot air boundary layer 22 is generated in use of the module 10. It is to be understood that the terms “hot” and “cool” are relative terms and do not limit the disclosure to particular temperatures. FIG. 3 shows a COMSOL Multiphysics® simulation using the Heat Transfer Module of free convection from the module front surface (i.e. 12) and rear surface (i.e. 14). In use, air that is in close proximity to the rear surface is heated due to the module 10 adsorbing thermal radiation. In the embodiment of FIG. 3, the module is 1.2 m long, angled at 30° to the horizontal and simulated to absorb 800 W/m². Because the air heated up at the rear surface cannot diffuse upwards as it is confined to the rear surface, a convection current is formed extending from the lower (left) region to the higher (right) region until it breaks free at a top edge. As shown in FIG. 3, the temperature of the air mass increases as it moves up the rear surface 14 of the module 10. It is this heated air mass that forms the hot air boundary layer 22. The movement of the heated air mass is generally laminar in nature across the rear surface. It should be appreciated that the properties (for example thickness and temperature) of the heated air boundary layer 22 changes depending on the size, shape, orientation and operational temperature of the module 10 and the ambient conditions (wind speed and direction, temperature, etc.). The boundary layer is typically millimetres to centimetres thick.

Because the distal end of the triangular flap 18 extends past the hot air boundary layer 22, the distal end 19 is in contact with air at a temperature lower relative to the hot air boundary layer, such as ambient temperatures (i.e. the dark blue region on FIG. 3 between 0.0-0.05° C. above ambient). As the hot air mass moves up the rear surface of the module 10 it interacts with a region of the triangular flap 18 near the attachment point 16. This interaction changes the laminar flow of the hot air mass to a vortex flow. This vortex flow helps to suck in and mix the cooler air positioned outside of the boundary layer 22 in proximity to the region of the triangular flap 18 that is above the hot air boundary layer 22. In addition to or in place of the change of laminar flow to vortex flow, in some embodiments the interaction changes the laminar flow to turbulent flow. A simulation of the interaction of laminar flow to vortex flow is shown in FIG. 2. For reference, the view of FIG. 2 is looking towards the rear surface at a perpendicular angle relative to the plane of the rear surface 14. The flow direction is from the left to the right in FIG. 2. In the embodiment of FIG. 2, the local increase in the heat transfer coefficient due to change from laminar flow to vortex flow was surprisingly large given the low effective Reynolds number associated with the flow. In the embodiment of FIG. 2, the triangular flaps provided a rather dramatic increase in heat transfer coefficient of the module.

The triangular flaps 18 are generally planar and the planar face is orientated approximately perpendicular to a flow direction of the hot air mass. Although planar triangular flaps are described in FIGS. 1 and 2, other structures that extend beyond the hot air boundary layer 22 and that disrupt the laminar flow in the boundary layer by introducing vortex flow (and/or turbulence) can be used, such as square, circular, rectangular and/or polygon structures. For example, the triangular flap may be twisted to promote more efficient mixing. The optimal shape and geometries of the flap, angles between the flap and the base plate, and the spatial orientation of respective flaps, will be dependent on the fluid dynamics of the air mass, the size of the module, and the expected temperature(s) generated in use of the module. For example, more flaps 18 may be provided towards a top 17 of the module 10 where the air mass is the hottest to provide greater mixing of cooler air with the hot air boundary layer 22.

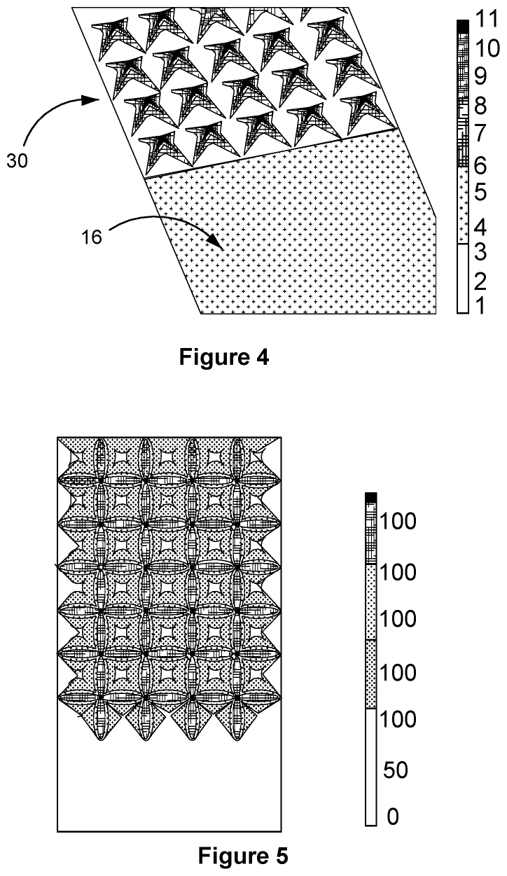

In another embodiment, as shown in FIG. 4 and FIG. 5, the protrusions take the form of a plurality of tessellated pyramids 30. The pyramids have a width that extends along with attachment point 16, and a height that extends above the attachment point 16. In the embodiments of FIGS. 4 and 5, the width is about double the height. In some embodiments, the width is 1.0 cm and the height is 0.5 cm. Although the heat transfer coefficient, h, is highest near the pyramid peaks (FIG. 4), the projected area value for the textured region is 3.5 W/m²/K, slightly lower than that of the planar segment (3.6 W/m²/K). However, the radiative emission is about 10% higher per projected area (FIG. 5), attributed to better angular emissivity. In some embodiments, the protrusions take on more than one form. For example, the protrusions may be a combination of triangular flaps 18 and pyramids 30.

In some embodiments, the assembly 20 is applied to existing photovoltaic modules. This allows existing photovoltaic modules to be retrofitted with the assembly 20 to help reduce the temperatures generated in use by the assembly. In some embodiments, the attachment points or areas 16 are points or areas of a large sheet or strip with a plurality of flaps 18 and that can be cut to size by an installer. The installer can install the sheet or strip to existing or new photovoltaic modules.

FIG. 7 shows an embodiment of a photovoltaic module 102 comprising a radiation receiving surface in the form of top (or front) surface 102 and a second surface in the form of bottom (or rear) surface 104 opposite the top surface 102. The bottom surface 104 has a layer of electrically insulating and thermally conductive material in the form of plate 106, which is in thermal communication (e.g. in contact) with a portion of the frame 108. The frame 108 is mounted to a support structure (not shown in FIG. 7). In some embodiments the plate 106 is in the form of a film.

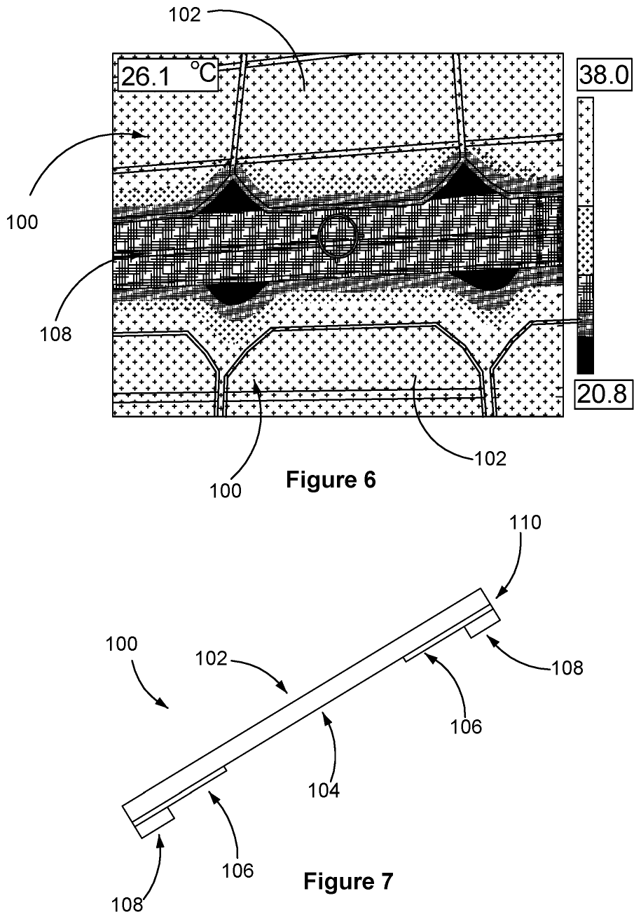

The plate 106 is configured to increase a heat transfer coefficient between the module 100 and the frame 108 compared to a module without the layer of electrically insulating and thermally conductive material. Put another way, plate 106 helps to increase lateral heat conduction across the plane of the module 100. Such conduction allows the heat absorbed by the module 100 to be transferred to the frame 108. If the frame 108 is able to act as a heat sink, then in some embodiments there is a net conductive flow of heat from the module 100 to the frame 108. As shown in FIG. 6, the frame 108 is cooler than the module 100.

FIG. 6 shows the approximate temperature distribution in two field-installed modules near the module frames. Temperatures within the module 100, ranging from 20.8 to 38.0° C., are reasonably accurate due to the high emissivity of glass over the detector's response range (5-14 um), while the temperature of the frame, indicated as 26.1° C. (circled area) is probably inaccurate (due to its different emissivity) since it is clear heat is flowing to the frame from the module. The overlap of the optical and thermal images is also not perfectly aligned due to the different positioning of the camera's two lenses. An analysis of this situation gives a diffusion length for the heat moving from the nearest cell to the frame given by the adjacent expression:

$${L}_{th} = \sqrt{\frac{\sum κ w}{H}} \approx \sqrt{\frac{1.1 \times 0.0032}{30}} = 0.011 m = 1.1 cm$$

where κ is the thermal conductivity of the layers providing lateral transport, mainly the glass coversheet, and H is the overall module heat transfer coefficient, typically 30 W/m²/K. The total heat loss to the frame is then approximated by Q_{IN}Lₜₕ²P/min(Lₜₕ,S) where P is the perimeter of the module, and S is the distance from the nearest cell to the frame (about 1 cm) giving 50 W for Q_{IN}=800 W/m2, Lₜₕ=1.1 cm and P=5.2 m. Spacing the cells closer than Lₜₕ to the frame would increase this loss, provided heat can flow readily from glass of the module 100 to the frame 108. The above formula assumes the frame is at a temperature close to ambient. In some embodiments, keeping the frame near ambient temperatures is ensured by adding an additional layer to the frame to maintain good reflection at visible wavelengths, while increasing infrared emissivity.

In some embodiments the plate 106 is integrated into the module 100 during manufacture of the module 100, while in other embodiments the plate 106 is applied (e.g. retro fitted) to existing modules. In the embodiment of FIG. 7, the plate 106 is shown as being a single layer. However, the plate 106 in some embodiments is made from a plurality of layers. The layers can include layers of film. A variety of different electrically insulating and thermally conductive materials can be used for the layers.

In some embodiments, the plate 106 is made from or includes a metal thermal conductor that is insulated from the module. For example, the plate can be alumina- or copper-based, such as tape-cast alumina of similar thickness to the cell used to make the module 100. In some embodiments the plate 106 is positioned only near the edge 110 of the module. Although not shown in FIG. 7, in some embodiments the plate 106 is also positioned to be in thermal communication with support structure. For example, a segment of thermally conductive tape can extend from the bottom surface 104 to the frame 108 to a support structure. This would make the frame 108 and support structure a heat sink for the module 100. Such an arrangement would facilitate transfer of heat from the module 100 to the frame 108 and/or support structure, which would lower the temperature of the module 100 in use.

In one embodiment, the plate 106 is provided as a thermally conductive electrical insulator that is used to electrically insulate the module from the frame 108. When used on frameless modules, the plate 106 is in thermal communication with an associated support structure. In these embodiments the plate 106 can help to provide the mechanical properties of the module 100 so that it is more resilient to incidences such as hail strikes and knocks during installation.

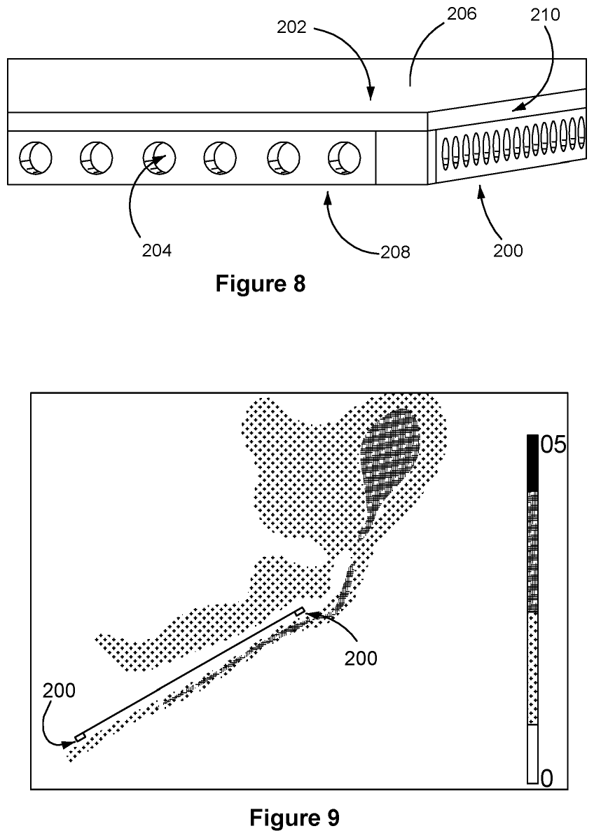

FIG. 8 shows an embodiment of a support frame 200 for mounting a photovoltaic module 202 to a support structure (support structure not shown). FIG. 8 only shows a corner portion of the module 202, where the frame 200 extends around a perimeter of the module 202. The frame 200 has one or more features in the form of apertures 204. The apertures 204 are configured to control one or more convection currents associated with the use of the photovoltaic module. For example, the apertures 204 can be used to direct the laminar flow of the hot air mass in FIG. 3 around the edges of the module 10. The frame 200 has a generally square cross-sectional profile, but in other embodiments the frame 200 has a cross-sectional profile that promotes favourable air flow across the top 206 and bottom 208 surfaces of the module 202. For example, the frame 200 may be profiled to resemble an aerofoil to enable easier escape of hot air. The effect of the frame 200 on the convection currents generated in use of the module 202 can be seen in FIG. 9. Compared to the airflow of FIG. 3, the frame 200 disrupts the laminar airflow at the top edge of the module.

In large fields, modules are shielded from wind by fencing and by adjacent rows of panels with wind possibly channeled along preferred directions. Providing a frame that promotes beneficial airflow may help to minimise some of the effects associated with the physical location of the module.

In some embodiments, the frame 200 wraps around the edge 210 of the module 202 (not shown). In these embodiments, the frame 200 can be used to connect adjacent frameless modules. In these embodiments, the frame 200 can have features such as apertures and fins that assist in shunting hot air out from the underside of the module and sucks in cool air.

Although apertures 204 have been described in FIG. 8, it should be appreciated that other formations and features, such as fins, conduits, protrusions, valleys, divots and so on, can be used to control the flow of air in and around the frame to assist in convection losses from the module 202. Further, the embodiment of FIG. 8 has the frame 200 being a separate structure that is attached to the module 202, but in other embodiments the frame 200 is integral with the module 202.

The various embodiments described above can be combined to provide a module with more than one way to promote conductive and convective cooling. For example, in one embodiment, a photovoltaic module includes the plate 106 from FIG. 7, the attachment 16 and triangular flap 18 from FIG. 1, and the frame 200 from FIG. 8. In this combinational embodiment, the flap 18 can be extend from plate 106. In another embodiment, the frame 200 is provided as the plate 106. Therefore, in some embodiments, a system for cooling a photovoltaic module is provided. The system can comprise the attachment point 16 and fin 18 arrangement, the plate 106 and/or frame 200. The system can be applied to existing or new photovoltaic modules.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art is referred to herein, such reference does not constitute an admission that the prior art forms a part of the common general knowledge in the art, in Australia or any other country.

1. An assembly for mounting to a photovoltaic module, the photovoltaic module having a radiation receiving surface and a second surface opposite the radiation receiving surface, at least one of the radiation receiving surface and the second surface also being arranged to transmit radiation, and a photon absorbing material positioned between the first and second surfaces, the assembly comprising:
a cooling element configured to mount to at least one of the radiation receiving surface and the second surface, the cooling element having a plurality of protrusions that are configured to increase a heat transfer coefficient of the photovoltaic module compared to a heat transfer coefficient that the photovoltaic module would have without the plurality of protrusions.

2. The assembly of claim 1, wherein the protrusions extend away from the second surface.

3. The assembly of claim 1, wherein the protrusions are configured for indirect or direct attachment at respective attachment points or areas to at least one of the radiation receiving surface and the second surface.

4. The assembly of claim 1, wherein each protrusion has a proximal end configured for attachment to at least one of the radiation receiving surface and the second surface and a distal end opposite the proximal end, and wherein each protrusion is sized so that the distal end extends past a hot air boundary layer that is generated in use of the photovoltaic module.

5. The assembly of claim 4, wherein each protrusion is sized so that, in use of the module, a substantially laminar flow convection current comprising the hot air boundary layer moves past each protrusion and each protrusion disrupts the laminar flow to form vortices, wherein vortex flow of the vortices mixes cooler air positioned adjacent the hot air boundary layer to cool the hot air boundary layer and the module.

6. The assembly of claim 1, wherein the protrusions are flaps.

7. The assembly of claim 6, wherein the flaps are substantially triangular in shape, wherein a corner of each triangular shape is configured to be positioned proximal to a plane of at least one of the radiation receiving surface and the second surface for attachment at an attachment point and an edge of the triangle is positioned distally away from the plane of at least one of the radiation receiving surface and the second surface.

8. The assembly of claim 1, wherein the protrusions are provided as a plurality of pyramids extending away from at least one of the radiation receiving surface and the second surface.

9.-11. (canceled)

12. A photovoltaic module comprising:
a radiation receiving surface;
a second surface opposite the radiation receiving surface, at least one of the radiation receiving surface and the second surface also being arranged to transmit radiation; and
a plurality of protrusions extending from at least one of the radiation receiving surface and the second surface, the protrusions being configured to increase a heat transfer coefficient of the photovoltaic module compared to a heat transfer coefficient that the photovoltaic module would have without the protrusions.

13. (canceled)

14. A photovoltaic module comprising a radiation receiving surface and a second surface opposite the radiation receiving surface,
wherein the second surface comprises a layer of electrically insulating and thermally conductive material configured to engage with a support frame that mounts the module to, or comprises, a support structure, and
wherein the layer of electrically insulating and thermally conductive material is configured to increase a heat transfer coefficient between the module and the support frame compared to a heat transfer coefficient that the module would have without the layer of electrically insulating and thermally conductive material.

15. The module of claim 14, wherein the layer of electrically insulating and thermally conductive material is integrated into the module.

16. The module of claim 14 or 15, wherein the layer of electrically insulating and thermally conductive material is one of a plurality of layers.

17. The module of claim 14, wherein the layer of electrically insulating and thermally conductive material comprises a metallic thermal conductor that is electrically insulated from the module.

18. A support frame for mounting a photovoltaic module to a support structure, the photovoltaic module having a radiation receiving surface and a second surface opposite the radiation receiving surface, the support frame in use absorbing heat from the photovoltaic module, the support frame comprising:
one or more features being configured to promote heat transfer from the support frame to the surroundings including a convection current when the photovoltaic module is exposed to a flow of air during use of the photovoltaic module.

19. The support frame of claim 18, wherein the one or more features include protrusions and valleys.

20. The support frame of claim 18, wherein the one or more features includes apertures in the support frame.

21. (canceled)

22. The support frame of claim 18, wherein the support frame is integral with the module.

23. The support frame of claim 18, wherein the support frame extends around a perimeter of the photovoltaic module.

24. The support frame of claim 18, wherein the support frame is provided with a layer that substantially reflects light at visible wavelengths whilst increasing infrared emissions from the frame.

25. The support frame of claim 18, wherein the support frame is formed from an electrically insulating and thermally conductive material.

26.-28. (canceled)
